(19) United States
(12) Patent Application Publication
(10) Pub. No.: US 2012/0089349 A1
(43) Pub. Date: Apr. 12, 2012

(54) Method for Measuring the Orientation and the Elastic Strain of Grains in Polycrystalline Materials

(75) Inventors: Pierre BLEUET, Bourgoin Jallieu (FR); Patrice GERGAUD, La Buisse (FR); Romain QUEY, Saint Marcellin (FR)

(73) Assignee: Commissariat A L'Energie Atomique et aux Energies Alternatives, Paris (FR)

(21) Appl. No.: 13/270,097

(22) Filed: Oct. 10, 2011

(30) Foreign Application Priority Data
Oct. 11, 2010 (FR) 10 58209

(51) Int. Cl. G01L 1/25; G06F 19/00

(52) U.S. Cl. 702/42

(57) ABSTRACT

A method for measuring the orientation and deviatoric elastic strain of the crystal lattice of grains contained in a sample of polycrystalline material comprising a set of grains (G1, . . . Gi, . . . , Gn) comprises recording a series of Laue patterns and an operation for deinterlacing said Laue patterns, which deinterlacing operation may advantageously be combined with a tomography operation so as to furthermore identify the spatial extent of said grains.

### CROSS-REFERENCE TO RELATED APPLICATION

This application claims priority to foreign French patent application No. FR 1058209, filed on Oct. 11, 2010, the disclosure of which is incorporated by reference in its entirety.

### FIELD OF THE INVENTION

The field of the invention is that of characterization of structures and mechanical fields in polycrystalline materials by X-ray diffraction. Most materials (in the fields of microelectronics, renewable energy, alloys, ceramics and inorganic materials) consist of crystals of different size, shape and structure for which measurement of the orientation and strain is important.

### BACKGROUND

Conventional classifications are:
single-crystal materials: a single large crystal is studied;
polycrystalline materials: a few tens of crystals are studied; and
powders: thousands of crystallites are studied.

The present invention more precisely relates to the second case.

X-ray diffraction is a technique currently used to characterize crystals. In the case of a polycrystal, the usual method consists in illuminating the sample with a high-energy polychromatic X-ray beam (called a “white” beam). An image comprising many diffraction spots is thus measured on a 2D detector, the image being called a Laue pattern, the spacing between the spots making it possible to characterize the space group, the orientation and the deviatoric elastic strain (change in shape of the crystal lattice) of a grain. To obtain the complete elastic-strain tensor experimentally, it is then necessary to use a monochromatic beam so as to obtain the hydrostatic component of the strain tensor (dilation of the grain).

FIG. 1 thus shows a schematic of a sample E_{ch} irradiated by a “white” beam S₀, the beam being said to be “white” because it contains X-rays of a plurality of wavelengths, notably a wavelength λ₁ and a wavelength λ₂, the beam being diffracted by two crystal planes P₁ and P₂ subjected to the same beam S₀ containing the two wavelengths λ₁ and λ₂. Measurement of the diffracted beams S_{λ1} and S_{λ2} using a CCD detector referenced C makes it possible to determine the orientation of the grain and the crystal structure.

Specifically, the “white” beam illuminates a grain and generates a set of diffraction spots on the 2D detector, each spot corresponding to diffraction of one of the wavelengths of the incident beam by a crystal plane. The diffraction spots correspond to particles, generally called in the present application digital image particles. In fact Bragg's law λ8=2dₕₖₗ sin θ_{B}, θ_{B} being the Bragg angle, is true a multitude of times because the multitude of wavelengths λ₁, λ₂, . . . λ_{N} place a multitude of crystal planes place under diffraction conditions.

The vector difference S_{λ1}−S₀ is normal to the direction n₁, S_{λ1} being the direction in which the plane P₁ forms the Laue spot T_{Laue1}; the vector difference S_{λ2}−S₀ is normal to the direction n₂, S_{λ2} being the direction in which the plane P₂ forms the Laue spot T_{Laue2}.

More precisely, the Laue method is a radiocrystallography method that consists in collecting a diffraction pattern from a crystal using a polychromatic X-ray beam. For a given wavelength, an incident beam is described by its wavevector \vec{k} directed in the propagation direction of the beam and of magnitude 2π/λ. The polychromatic beam is considered to contain all the wavelengths between two values, a minimum value λₘᵢₙ and a maximum value λₘₐₓ. A diffracted beam is likewise described by its wavevector \vec{k}′. The two vectors \vec{k} and \vec{k}′ make it possible to define the scattering vector, often denoted \vec{Q}:

\vec{Q}=\vec{k}′−\vec{k}.

The directions in which the scattered beams interfere constructively are then given by the Laue condition: the end of the scattering vector must coincide with a reciprocal-lattice node. Since the crystal is stationary, it is useful to illustrate the Laue method geometrically by drawing the location of the ends of this vector.

Since only elastic scattering is of interest, i.e. waves scattered with the same energy as the incident beam, for a given wavelength only scattering vectors having the same wavelength as the wavevector of the incident beam will be considered. When the scattered beam describes all possible orientations, the end of the scattering vector describes a sphere of radius 2π/λ, called the Ewald sphere. Taking account of all the wavelengths present in the incident beam, a family of spheres is obtained. All the nodes present in this zone diffract, and therefore may produce a diffraction spot on the detector.

Generally, a Laue pattern is a distorted image of the reciprocal lattice. Spots located on a conic section (ellipses or hyperbola branches) on the pattern correspond to aligned points in the reciprocal lattice. In addition, the various harmonics of a reflection are all coincident in the same spot.

Before carrying out a physical experiment on a crystal, it is often necessary to align it along a precise crystallographic direction. The Laue method makes it possible to do this easily. The crystal is placed on a goniometer head. The pattern obtained is a figure consisting of a set of spots representing all directions in reciprocal space. It is then necessary, at this level, to index the diffraction spots, i.e. to find the [hkl] values of the Miller indices of the directions in reciprocal space which caused diffraction, and to name them.

In a second step it is then possible to calculate the misorientation as a function of the point (hkl direction) to be corrected by bringing it, for example, to the center of the pattern, the correction angles having already been calculated using Greninger charts referenced as a function of the crystal/film distances. At the current time a plurality of software programs have been developed enabling indexing via superposition of theoretical and experimental patterns; they also make it possible to automatically calculate the angular corrections to be supplied to the goniometer head or the reorientation system.

This method is currently used in laboratory and synchrotron devices. The difficulty lies in processing the images: peaks must be sought and indexed and the distances and angles between peaks must be calculated.

It has already been suggested to use electron diffraction methods, and a number of variants have notably been described for measuring strains in an electron microscope: CBED (convergent beam electron diffraction), dark-field holography, and NBED (nanobeam electron diffraction). In the case of NBED, a sample is illuminated with a parallel electron beam and a diffraction pattern also consisting of a number of spots is recorded, which, by comparison with a standard, make it possible to determine the local stresses.

Nevertheless, in the case of single-crystal samples or samples comprising few crystals (one to three crystals in the volume probed), indexing of the spots, i.e. assignment of Miller indices to each spot, is possible.

Typically, with a germanium single crystal, a diffraction image is obtained comprising about ten spots that are easily indexed.

In the case of a properly polycrystalline sample, containing approximately ten or twenty grains that diffract simultaneously, indexing is impossible because there is no single solution but rather a plurality of solutions due to the spots (several hundred) many.

It is therefore not generally possible to treat the cases where more than five grains are illuminated at the same time by the beam. This limitation is valid both for X-ray diffraction and for electron beam diffraction.

To determine the crystal orientation and strain field a sample is swept in front of a beam the width of which is about the same as the size of the grains. A focusing lens L_{f} focuses a polychromatic beam onto a sample; the beams diffracted by said sample are imaged on a detector, forming patterns or images.

A method for localizing the grains by sliding a wire between the sample and the detector has already been suggested in the literature, and notably in the article by B. C. Larson, Wenge Yang, G. E. Ice, J. D. Budai and J. Z. Tischler, “Three-dimensional X-ray structural microscopy with submicrometre resolution” Nature 415, 887-890 (21 Feb. 2002) doi:10.1038/415887a. This method makes it possible to localize grains via triangulation but does not allow them to be imaged. The principle consists in successively blocking off diffraction spots by sliding a wire between the sample and the detector, thereby allowing a posteriori individual reconstruction of the Laue patterns.

However, this method is awkward in that it requires the use of a sliding wire.

### SUMMARY OF THE INVENTION

The present invention includes a novel method for measuring the orientation and deviatoric elastic strain of grains in polycrystalline materials using an operation for geometrically deinterlacing Laue patterns.

More precisely, the subject of the invention is a method for measuring the orientation and deviatoric elastic strain of grains contained in a sample of polycrystalline material comprising a set of grains, characterized in that it comprises the following steps:
illuminating said sample, in a first direction, with a polychromatic beam of radiation that is able to be diffracted by said grains;
recording a first series of a first number of images with a planar detector taking images in a first plane defined by said first direction and by a second direction, said images being Laue patterns comprising the diffraction spots corresponding to digital image particles specific to each of said grains, said images being taken in succession on moving said sample, said movement being in a third direction perpendicular to said plane;
concatenating the first series of images in a volume the three dimensions of which are those of the planar detector and that of the movement;
looking for particles in said volume using 3D-connectivity analysis (as described in patent FR 2 909 205) enabling said particles in said volume to be discretized;
calculating the centers of mass for each of the particles for each of said grains, making it possible to define coordinates relative to said particles, in said plane and in the third direction;
defining the set of coordinates in said first plane in said first and second directions starting from the positions of said centers of mass, so as to form elementary Laue patterns relative to each of said grains; and
indexing said elementary Laue patterns relative to each of said grains so as to define the orientation and the strain of the crystal lattice of said grains.

According to one variant of the invention, the method furthermore comprises defining the spatial extent of each grain in the third direction by measuring the size of the digital image particle along said third direction using the connectivity analysis.

The concatenation of 2D images makes it possible to form a 3D image and to use 3D-image processing (3D connectivity) to discretize the spots (i.e. to separate the spots of the various grains). This concatenation is based on digital processing of projections of an object via mathematical reconstruction. The method of the present invention thus provides for 3D digital processing of concatenated 2D Laue patterns.

The benefit of the invention notably lies in the application of tomography, tomography notably being described in the article by Avinash C. Kak and Malcolm Slanet “Principles of Computerized Tomographic Imaging” IEEE.

According to one variant of the invention, the method comprises recording a first set of more than one series of images, each series of images being taken on turning the sample by an angular step about an axis parallel to said second direction, so as to rotate the plane defined by the first and third directions, so as to define the extent of said grains in said first direction.

According to another variant of the invention, the method furthermore comprises recording a second set of more than one series of images, each series of images being taken on moving the sample by a step in said second direction, so as to define the extent of said grains in said second direction.

According to another variant of the invention, the analysis beam has a diameter of about a micron, the movement step being about half a micron.

According to another variant of the invention, the detector is an energy resolution detector that makes it possible to obtain the complete strain tensor by directly measuring the energy value of one of the spots on this detector, this value being an input parameter for a standard XMAS (X-ray microanalysis software) program for calculating the complete tensor.

According to another variant of the invention, the method furthermore comprises a step of processing the Laue patterns obtained, making it possible to determine the dilation state of each of the grains.

According to another variant of the invention, the method furthermore comprises a mathematical calculation step using equations for the mechanical equilibrium between two adjacent grains and the mathematical relationship between global and local stresses making it possible to define the compression state of each of the grains.

According to another variant of the invention, the energy beam is an X-ray beam.

According to another variant of the invention, the energy beam is an electron beam.

According to another variant of the invention, the energy beam is a neutron beam.

### BRIEF DESCRIPTION OF THE DRAWINGS

The invention will be better understood and other advantages will become clear on reading the following description given by way of nonlimiting example and by virtue of the appended figures among which:

FIG. 1 illustrates the recording of Laue patterns according to the prior art in the simplified case of a two-grain sample;

FIG. 2 illustrates an exemplary device enabling implementation of the method of the present invention; and

FIGS. 3a to 3d show schematics of the various steps of the method according to the invention.

### DETAILED DESCRIPTION

The method of the present invention generally comprises recording a series of diffraction patterns or images from a polycrystalline sample comprising a number of grain types, the various patterns being produced by moving said sample perpendicularly to the irradiating beam. The diffraction spots correspond to particles, called digital image particles in the present description. The method of the present invention relates to the processing of these digital particles in order for the Laue patterns to be completely deinterlaced so as to determine crystallographic information specific to each of the grains present in the polycrystalline sample analyzed.

The following description concerns irradiation of the sample using an X-ray beam. Nevertheless, the present invention may equally well be applied in the context of an electron or neutron beam.

Typically, in the case of grains with a grain size of about a few microns, and when using an X-ray beam about 1 micron in diameter, the displacement step between two positions Zₗ of the detector may be about half a micron. However, the method may be generalized to any dimensions, provided that the above size ratios are respected. Generally, the sample is moved to M positions relative to the detector.

The principle of the invention consists in detecting spots or digital image particles common to a number of images in succession, and therefore originating from one and the same grain.

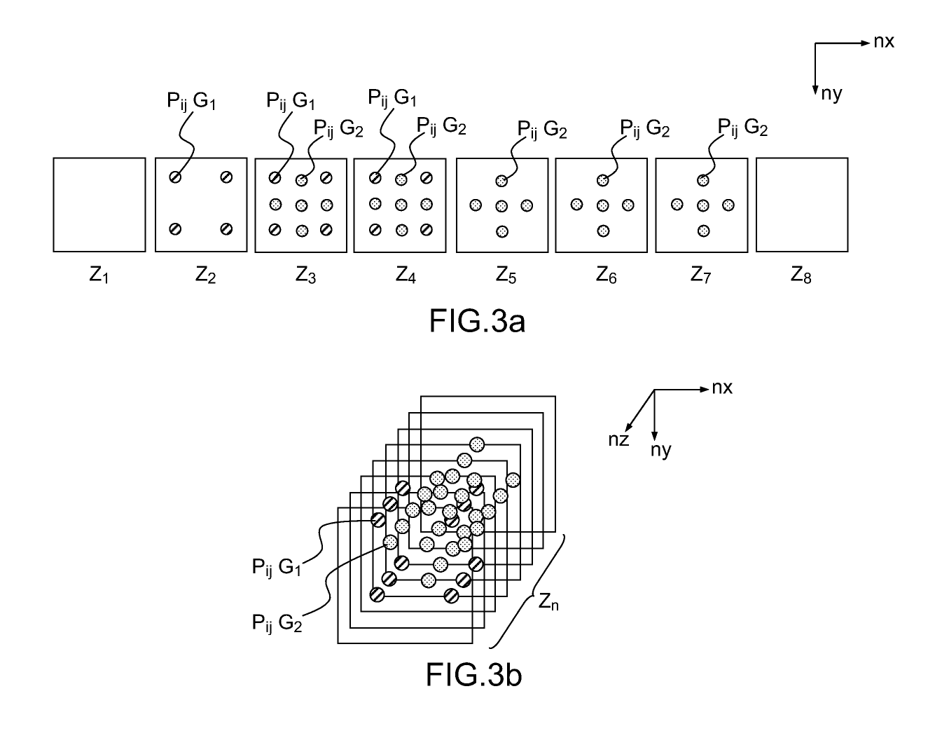

In the rest of the description, a set of k grains Gk is considered to generate, by X-ray diffraction, in the recorded images, digital particles the positions P_{ijGk} of which are located in an image plane with axes X and Y. FIG. 2 illustrates a possible configuration for implementing the method of the invention. An X-ray beam FX is focused by a lens L_{f} onto the sample to be analyzed E_{ch} in a direction X. A detector D is placed perpendicular to the beam so as to be able to record images in a plane P defined by the directions X, Y. Means (not shown) for enabling said sample to be moved along the Z-axis, perpendicular to the X-axis and the Y-axis are provided. The detector records Laue images or patterns I_{ZL}.

According to the present invention, it is proposed to record a series of diffraction patterns in each position Z_{L} along the Z-axis, corresponding to the first step of the method of the invention.

For a polycrystalline sample comprising k grains Gₖ, the particles P_{ijGk} are characterized, on an image, by a number N_{PijGk} and by positions X_{PijGk} and Y_{PijGk}.

The first step of the method consists in carrying out M recordings in succession, associated with M movements of the sample relative to the beam and defining positions Z_{L} of the sample.

Next, an operation concatenating the set of 2D images is carried out, leading to the construction of a 3D data volume: (Z_{L}, X_{PijGk}, Y_{PijGk}).

Next 3D particles are sought in this volume using 3D connectivity analysis, making it possible to discretize the particles, which have overlap zones.

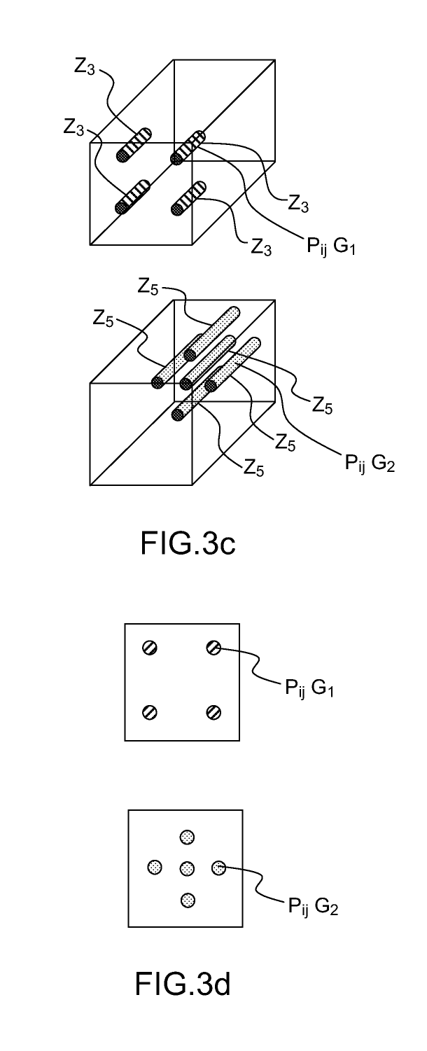

To illustrate this idea, FIGS. 3a and 3b show an exemplary simplified sample comprising only two grain types G₁ and G₂.

Thus FIG. 3a illustrates a succession of M positions for the sample with M=8, thus generating 8 images of the simplified set of two grains, and generating respectively a set of particles P_{ijG1} and P_{ijG2}, the images being captured by shifting the sample relative to the beam in steps of Δz along the Z-direction.

Thus it may be seen that:
in position Z₁: no grain particle is observed in the image I_{Z0};
in position Z₂: particles P_{ijG1} feature in the image I_{Z2};
in position Z₃: particles P_{ijG1} and P_{ijG2} feature in the image I_{Z3};
in position Z₄: particles P_{ijG1} and P_{ijG2} feature in the image I_{Z4};
in position Z₅: particles P_{ijG2} feature in the image I_{Z5};
in position Z₆: particles P_{ijG2} feature in the image I_{Z6};
in position Z₇: particles P_{ijG2} feature in the image I_{Z7}; and
in position Z₈: no grain particle is observed in the image I_{Z8}.

In a second step of the method of the invention, the set of recorded images is concatenated, so as to create a 3-dimensional set the dimensions of which correspond to those of the planar detector and to the number of images recorded along the Z axis (8 in the present example).

Next, an operation for seeking 3D particles in this volume is carried out using connectivity analysis, so as to define the data set inherent to the positions (Z_{L}, X_{PijGk}, Y_{PijGk}) of particles P_{ijG1} and P_{ijG2} in the three directions, as illustrated in FIG. 3b.

Based on this operation, the center of mass of each particle is calculated. This makes it possible to construct a table of the centers of mass of all the particles with a subvoxel resolution.

Thus, in the simplified example: a first relative set of images (I_{Z2}, I_{Z3}, I_{Z4}) having the coordinates (X_{PijG1}, Y_{PijG1}) and a second relative set of images (I_{Z3}, I_{Z4}, I_{Z5}, I_{Z6}, I_{Z7}) having the coordinates (X_{PijG2}, Y_{PijG2}), are isolated. FIG. 3c shows these two sets.

The center of mass of each particle is calculated. This makes it possible to construct a table of the centers of mass of all the particles, with a subvoxel resolution.

All the particles having the same center of mass Z_{L} coordinates necessarily belong to the same grain since the center of mass corresponds to the maximum of the diffracted intensity and since two grains are not located in the same position in Z. If two grains are behind one another (in X), their center of mass in Z in the 3D volume may be the same and it will not be possible to differentiate them.

Typically, the center of mass of the grain G₁ has coordinates Z₃, whereas the relative center of mass of the grain G₂ has coordinates Z₅.

For all the coordinates Z_{M} of the centers of mass thus found, the corresponding coordinates X_{PijG1} and Y_{PijG1} are read and new, refined Laue patterns based on regions of interest about each spot are digitally reformed.

Insofar as the calculation of the center of mass is subvoxel, it is possible to oversample in Z and therefore create intermediate Laue patterns, thereby increasing the separation of the grains from one another. FIG. 3d illustrates this step of the method for the case of the simplified sample with two grains.

All the refined Laue patterns are indexed using a standard prior-art method.

Once each image has been indexed, it is possible to determine the spatial extent, along the Z-axis, of a grain by looking at the size of the 3D particle found during the connectivity-analysis operation, used to look for particles. It is possible for this step to be carried out for all the grains, and thus for all the grains to be indexed.

Typically, in the case of the simplified example, the size of the grain G1 in Z is derived from the presence of particles P_{ijG1} in the three images corresponding to positions Z₂, Z₃ and Z₄. Calculating the difference between the position of the sample at Z₂ and Z₄ gives the size of the grain G1 along Z.

For the grain G2, the particles relating to this grain are present in 5 images, therefore the grains have a spatial extent along the Z-axis of 2.5 microns.

In order to completely resolve the arrangement of the grains and also to know the spatial extent of the grains in the X-direction, it is possible to rotate the sample, after each linear movement along the Z-axis, and restart a new sweep. This dual sweep (linear movement/rotation) is applied until a 360-degree rotation has been covered.

A set of more than one series of images I_{pNZ,φ} is produced, each series of images being taken by turning the sample by an angular step φ about the Y-axis, so as to rotate the plane defined by the first and third X- and Z-directions, in order to determine the extent of said grains in said X-direction.

For each angle, a “projection” of each grain is obtained, this is then a tomography imaging operation using Laue diffraction in the context of the present invention. The distribution (z, φ) of each grain thus obtained makes it possible, using mathematic reconstruction algorithms, analogous to the algorithms used in medical scanners, to determine the 2D shape of the grain in said first and third directions. In addition to the shape, the indexing step yields the crystal orientation of the grain and the distortion of the crystal lattice by virtue of the deviation from symmetry of the undeformed crystal.

Finally, in order to determine the spatial extent of the grains in the Y-direction, and thus to obtain a 3D image of the grains, the method of the invention may also advantageously comprise recording a second set of more than one series of images I_{pNZ, Y}, each series of images being produced by moving the sample by a step ΔY in said second direction Y, so as to determine the extent of said grains in said second direction Y.

Combining all of the operations described above makes it possible to define the extent of each of the grains in three dimensions in the Z-, X-, and Y-directions. The indexing step yields, in addition to the 3D shape, the orientation and the deviatoric strain tensor using standard software programs such as XMAS or OrientExpress.

To carry out the recordings necessary for implementating the method of the present invention, it may be very advantageous to use a 2D detector having sufficient energy resolution so as to avoid having to carry out both polychromatic and monochromatic measurements.

With Laue diffraction, what is called a polychromatic or “white” beam is used, i.e. a beam containing a plurality of wavelengths (or energies). This white beam illuminates a grain and generates a set of diffraction spots on a 2D detector, each spot corresponding to diffraction from a crystal plane by one of the wavelengths of the incident beam.

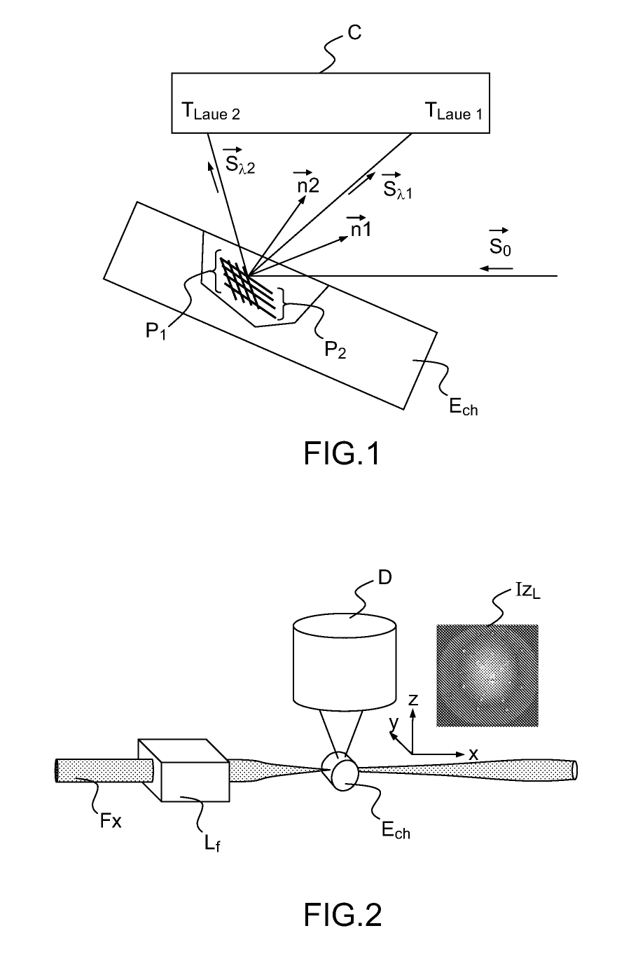

In FIG. 1 presented above, two crystal planes P₁ and P₂, in one and the same grain, may be seen to diffract because they are subjected to a beam containing two wavelengths λ₁ and λ₂. Measurement using a CCD camera makes it possible to determine the crystal orientation of the grain (there is a relationship between the position of the spot T_{Laue} on the CCD and the crystal orientation of the grain, this is Bragg's law) and the angular elastic strain of the crystal lattice of this grain but not the change in size of the crystal lattice. It is therefore possible to know whether the crystal structure is distorted but it is not possible to know its hydrostatic strain or its dilation.

To do this it is necessary to know the wavelengths of the diffracted beams, which is not possible because a CCD camera is being used that does not provide information about the energy (or the wavelength) of the diffracted beams. At the present time, those skilled in the art use two analyses, a polychromatic analysis followed by an analysis using a monochromatic beam (with one common energy), thereby making it possible to know the energy of one of the spots. This analysis is made difficult by alignment problems, a statistically small dataset, and the difficulty of finding one and the same spot under polychromatic and monochromatic irradiation.

This is why it is advantageous to use a 3D detector, i.e. a detector that is spatially resolved (2D) and energy resolved. This type of detector is beginning to appear on the market.

With this type of detector the energy of each spot is obtained using only a single polychromatic examination, it is therefore possible to rapidly determine the crystal orientation of the grains, their angular elastic strain, and above all their change in size, by virtue of the wavelength of the spot thus measured by the 3D detector.

As an alternative to the energy resolution detector it is possible to calculate the same information. Generally, Laue tomography makes it possible to determine the shape of the grains and the spatial positions of the deviatoric elastic strain states. Hooke's law is then applied to determine the deviatoric stresses (the elastic modulus being known). Mechanical considerations make it possible to determine the hydrostatic stress states and therefore consequently the “complete” stress states (the complete stress tensor may be obtained).

These mechanical considerations are:
the expression of the local mechanical equilibrium within the material; and
the relationship between the local stresses and the macroscopic stress (i.e. the average stress in the material), which is known or experimentally measurable (it is zero if no load is applied to the material).

It is possible to associate a “complete” (deviatoric component+hydrostatic component) stress state with each point where the deviatoric stress is known. Thus all the information may be obtained: grain shape, crystal orientation of the grains and complete stress tensor of the grains.

The mechanical equilibrium between two adjacent positions X1 and X2 under stress states σ1 and σ2 is expressed as (an underlined character denotes a second-order tensor):

σ₁·n=σ₂·n (in the absence of volume forces) (1)

where n is the normal to the surface element between X1 and X2 (see FIG. 1).

By decomposing the stress states into their deviatoric components S and their hydrostatic components σ^{h}, the equality (1) becomes:

(S₁+σ^{h}₁)·n=(S₂+σ^{h}₂)·n (2)

i.e., on account of the fact that σ^{h}₁=σ^{h}₁ I and σ^{h}₂=σ^{h}₂ I (hydrostatic tensors) where I is the identity matrix, and by developing the expression

(σ^{h}₂−σ^{h}₁)I·n=−(S₂−S₁)·n where I is the identity matrix (3)

By noting that I·n=n, then by multiplying the equality by n, the following is obtained:

((σ^{h}₂−σ^{h}₁)·n)·n=−[(S₂−S₁)·n]·n (4)

By noting that n·n=1 (n is a unit vector):

(σ^{h}₂−σ^{h}₁)=−[(S₂−S₁)·n]·n (5)

By using the noteworthy identity (A·b)·b=A: (b×b), where A is a matrix and b a vector and : and x are the double contraction product and the dyadic product between two tensors, successively,

(σ^{h}₂−σ^{h}₁)=−(S₂−S₁): N where N=n×n (6)

Under mechanical equilibrium conditions, the difference between the hydrostatic stress states σ^{h}₁ and σ^{h}₂ may therefore be determined from the deviatoric stress states S₁ and S₂, and from n.

The relationship between local stresses and the macroscopic stress provides an additional relationship making it possible to determine the individual values of the hydrostatic stress states, σ^{h}₁ and σ^{h}₂. It is expressed as

$$\frac{\int σ \cdot d V}{V} = \underline{Σ} \qquad ( 7 )$$

where V is the volume of the sample considered, σ is the stress state at a given location on the sample, and Σ is the macroscopic stress state (0 for a sample that is not mechanically solicited).

For example, for the case of a bicrystal consisting of two grains having the same volumes, separated by a boundary of normal n, the relationship (7) becomes:

0.5 (σ₁+σ₂)=Σ (8)

thus, by considering only the hydrostatic component of the expression (8) and after elementary manipulation:

σ^{h}₁+σ^{h}₂=2 Σ^{h} where Σ^{h} is the hydrostatic component of Σ (9)

By combining relationships (6) and (9), the following is obtained:

σ^{h}₁=0.5 (S₂−S₁): N+Σ^{h} σ^{h}₂=−0.5 (S₂−S₁): N+Σ^{h} (10)

The “complete” stress states are therefore known perfectly,

σ₁=S₁+[0.5 (S₂−S₁): N]I+Σσ₂=S₂−[0.5 (S₂−S₁): N]I+Σ (11)

It will be noted that it may be advantageous to place an energy resolution detector near the sample so as to make it possible to measure X-ray fluorescence and therefore chemical composition. Thus it is possible to differentiate between two grains of identical space group even though Laue diffraction only differentiates grains based on space group and not on chemical composition. For example, a gold grain and a copper grain have the same space group but their fluorescence energy differs.

1. A method for measuring the orientation and deviatoric elastic strain of the crystal lattice of grains contained in a sample of polycrystalline material comprising a set of grains (G1, . . . Gi, . . . , Gn), comprising the following steps:
illuminating said sample, in a first direction X, with a polychromatic beam of radiation that is able to be diffracted by said grains;
recording a first series of a first number (M) of images (I_{1NZ}) with a planar detector taking images in a first plane (Pz, Py) defined by said first direction (X) and by a second direction (Y), said images being Laue patterns comprising the diffraction spots corresponding to digital image particles specific to each of said grains, said images being taken in succession on moving said sample in a third direction (Z) perpendicular to said plane, the movement of said sample being carried out in steps of Δz;
concatenating the first series of images in a volume the three dimensions of which are those of the planar detector (NX, NY) and that of the movement (NZ);
looking for particles in said volume using 3D-connectivity analysis enabling said particles in said volume to be discretized;
calculating the centers of mass for each of the particles for each of said grains, making it possible to define coordinates (X_{PijGk}, Y_{PijGk}, Z_{L}) relative to said particles, in said plane and in the third direction;
defining the set of coordinates (X_{PijGk}, Y_{PijGk}) in said first plane in said first and second directions (X, Y) starting from the positions (Z₃, Z₅, Z_{L}) of said centers of mass, so as to form elementary Laue patterns relative to each of said grains; and
indexing said elementary Laue patterns relative to each of said grains so as to define the orientation and the deviatoric elastic strain of the crystal lattice of said grains.

2. The method for measuring the orientation and deviatoric elastic strain of the crystal lattice of grains, as claimed in claim 1, further comprising defining the spatial extent of each grain in the third direction (Z) by measuring the size of the digital image particle along said third direction.

3. The method for measuring the orientation and the deviatoric elastic strain of the crystal lattice of grains, as claimed in claim 2, further comprising recording a first set of more than one series of images (I_{pNZ, φ}), each series of images being taken on turning the sample by an angular step (φ) about an axis parallel to said second direction, so as to rotate the plane defined by the first and third directions (X, Z), so as to define the extent of said grains in said first direction (X).

4. The method for measuring the orientation and the deviatoric elastic strain of the crystal lattice of grains, as claimed in claim 2, further comprising recording a second set of more than one series of images (I_{pNZ, Y}), each series of images being taken on moving the sample by a step ΔY in said second direction (Y), so as to define the extent of said grains in said second direction (Y).

5. The method for measuring the orientation and the deviatoric elastic strain of the crystal lattice of grains, as claimed in claim 2, the analysis beam having a diameter of about a micron, the movement step being about half a micron.

6. The method for measuring the orientation and the deviatoric elastic strain of the crystal lattice of grains, as claimed in claim 2, in which the detector is an energy resolution detector.

7. The method for measuring the orientation and the deviatoric elastic strain of the crystal lattice of grains, as claimed in claim 2, further comprising a mathematical calculation step using equations for the mechanical equilibrium between two adjacent grains and the mathematical relationship between global and local stresses making it possible to define the compression state of each of the grains.

8. The method for measuring the orientation and the deviatoric elastic strain of the crystal lattice of grains, as claimed in claim 2, in which the energy beam is an X-ray beam.

9. The method for measuring the orientation and the deviatoric elastic strain of the crystal lattice of grains, as claimed in claim 2, in which the energy beam is an electron beam.

10. The method for measuring the orientation and the deviatoric elastic strain of the crystal lattice of grains, as claimed in claim 2, in which the energy beam is a neutron beam.

11. The method for measuring the orientation and the deviatoric elastic strain of the crystal lattice of grains, as claimed in claim 1, further comprising recording a first set of more than one series of images (I_{pNZ, φ}), each series of images being taken on turning the sample by an angular step (φ) about an axis parallel to said second direction, so as to rotate the plane defined by the first and third directions (X, Z), so as to define the extent of said grains in said first direction (X).

12. The method for measuring the orientation and the deviatoric elastic strain of the crystal lattice of grains, as claimed in claim 1, further comprising recording a second set of more than one series of images (I_{pNZ, Y}), each series of images being taken on moving the sample by a step ΔY in said second direction (Y), so as to define the extent of said grains in said second direction (Y).

13. The method for measuring the orientation and the deviatoric elastic strain of the crystal lattice of grains, as claimed in claim 1, the analysis beam having a diameter of about a micron, the movement step being about half a micron.

14. The method for measuring the orientation and the deviatoric elastic strain of the crystal lattice of grains, as claimed in claim 1, in which the detector is an energy resolution detector.

15. The method for measuring the orientation and the deviatoric elastic strain of the crystal lattice of grains, as claimed in claim 1, further comprising a mathematical calculation step using equations for the mechanical equilibrium between two adjacent grains and the mathematical relationship between global and local stresses making it possible to define the compression state of each of the grains.

16. The method for measuring the orientation and the deviatoric elastic strain of the crystal lattice of grains, as claimed in claim 1, in which the energy beam is an X-ray beam.

17. The method for measuring the orientation and the deviatoric elastic strain of the crystal lattice of grains, as claimed in claim 1, in which the energy beam is an electron beam.

18. The method for measuring the orientation and the deviatoric elastic strain of the crystal lattice of grains, as claimed in claim 1, in which the energy beam is a neutron beam.
